(19) United States
(12) Patent Application Publication
(10) Pub. No.: US 2025/0101155 A1
(43) Pub. Date: Mar. 27, 2025

(54) METAL-LIGAND COMPLEX, CATALYST COMPOSITION FOR PRODUCING ETHYLENE-BASED POLYMER CONTAINING THE SAME, AND METHOD OF PRODUCING ETHYLENE-BASED POLYMER USING THE SAME

(71) Applicant: SABIC SK NEXLENE COMPANY PTE. LTD., Singapore (SG)

(72) Inventors: Dongcheol SHIN, Daejeon (KR); Miji KIM, Daejeon (KR); Minji KIM, Daejeon (KR); Yeonock OH, Daejeon (KR)

(21) Appl. No.: 18/725,531

(22) PCT Filed: Dec. 28, 2022
(86) PCT No.: PCT/IB2022/062827

§ 371 Date: Jun. 28, 2024

(30) Foreign Application Priority Data
Dec. 29, 2021 (KR) 10-2021-0190680
Dec. 21, 2022 (KR) 10-2022-0180789

(51) Int. Cl. C08F 210/16; C07F 7/00

(52) U.S. Cl. CPC C08F 210/16; C07F 7/003

(57) ABSTRACT

The present invention relates to a metal-ligand complex having significantly improved high-temperature activity due to an increase in resistance of a catalyst to impurities such as oxygen and moisture and stability through introduction of a specific functional group, a catalyst composition for preparing an ethylene-based polymer containing the same, and a method of producing an ethylene-based polymer using the same.

### TECHNICAL FIELD

The following disclosure relates to a metal-ligand complex, a catalyst composition for producing an ethylene-based polymer containing the same, and a method of producing an ethylene-based polymer using the same.

### BACKGROUND ART

Conventionally, in the preparation of an ethylene-based polymer such as a copolymer of ethylene and a-olefin or a copolymer of ethylene and olefin-diene, a so-called, a Ziegler-Natta catalyst system, which generally includes a main catalyst component of a titanium or vanadium compound, and a cocatalyst component of an alkyl aluminum compound, has been used.

U.S. Pat. Nos. 3,594,330 and 3,676,415 disclose improved Ziegler-Natta catalysts. However, though the Ziegler-Natta catalyst system exhibits high activity to ethylene polymerization, it has a disadvantage in that generally a produced polymer has a broad molecular weight distribution due to a heterogeneous catalyst active site, and in particular copolymers of ethylene and a-olefins have a non-uniform composition distribution.

Thereafter, various studies have been conducted on a metallocene catalyst system including a metallocene compound of transition metals of Group 4 in the periodic table such as zirconium and hafnium, and methylaluminoxane as a cocatalyst, wherein the metallocene catalyst system is a homogeneous catalyst having a single catalyst activity site and may prepare polyethylene having a narrow molecular weight distribution and a uniform composition distribution as compared with the conventional Ziegler-Natta catalyst system.

For example, European Patent Publication Nos. 320,762 and 372,632 disclose that a metallocene compound may be activated with cocatalyst methyl aluminoxane in Cp₂ TiCl₂, Cp₂ZrCl₂, Cp₂ZrMeCl, Cp₂ZrMe₂, ethylene (IndH₄)₂ZrCl₂, etc., to polymerize ethylene with high activity, thereby preparing polyethylene having a molecular weight distribution (Mw/Mn) in a range of 1.5 to 2.0.

However, it is difficult to obtain a high molecular weight polymer with the above catalyst system.

That is, it is known that when a solution polymerization method performed at a high temperature is applied, the polymerization activity is rapidly reduced and β-dehydrogenation reaction is dominant, which is unsuitable for producing a high molecular weight polymer.

Meanwhile, an organometallic catalyst often requires expensive production costs due to high difficulty and complexity of a production step. In addition, the catalyst may be exposed to the air during a production process or storage and transfer, and at this time, the activity of the catalyst may be significantly reduced, or in the worst case, there will be a situation in which the catalyst has to be discarded without being used. From the point of view of catalyst manufacturers or catalyst users, a catalyst that is stable to oxygen or moisture in the air must have a great advantage.

Therefore, there is still a need in the chemical industry for a catalyst and a catalyst precursor having improved properties required. Accordingly, studies on a competitive catalyst having characteristics such as excellent stability, high-temperature activity, re-activity with a higher α-olefin, and ability to produce a high molecular weight polymer have been urgently demanded.

### DISCLOSURE OF INVENTION

### Technical Problem

An embodiment of the present invention is directed to providing a metal-ligand complex having a specific functional group and a catalyst composition containing the same, in order to alleviate the conventional problems.

Another embodiment of the present invention is directed to providing a method of producing an ethylene-based polymer using the catalyst composition according to the present invention.

### Solution to Problem

The present invention provides a metal-ligand complex having significantly improved high-temperature activity due to an increase in resistance of a catalyst to impurities such as oxygen and moisture and stability at a high temperature through introduction of a specific functional group. In one general aspect, there is provided a metal-ligand complex represented by the following Chemical Formula 1:

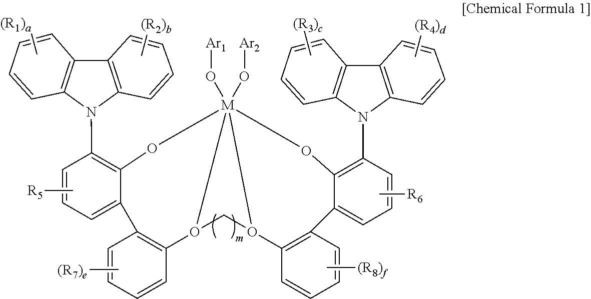

in Chemical Formula 1,
M is a transition metal of Group 4 in the periodic table;
Ar₁ and Ar₂ are each independently C₆-C₂₀aryl, and aryl of Ar₁ and Ar₂ may be further substituted with C₁-C₂₀alkyl;
R₁ to R₄ are each independently C₁-C₂₀alkyl, C₆-C₂₀aryl, or C₆-C₂₀arylC₁-C₂₀alkyl;
R₅ and R₆ are each independently C₁-C₂₀alkyl;
R₇ and R₈ are each independently halogen or C₁-C₂₀alkyl;
a, b, c, d, e, and f are each independently an integer of 0 to 4; and
m is an integer of 2 to 5.

In another general aspect, a catalyst composition for producing an ethylene-based polymer contains the metal-ligand complex according to the present invention and a cocatalyst.

In still another general aspect, a method of producing an ethylene-based polymer includes producing an ethylene-based polymer by polymerizing ethylene or ethylene and an α-olefin in the presence of the catalyst composition for producing an ethylene-based polymer according to the present invention.

### Advantageous Effects of Invention

The metal-ligand complex according to the present invention introduces a specific functional group, such that stability of the complex may be significantly improved, thereby promoting polymerization at a high polymerization temperature without deterioration of the catalytic activity.

In particular, the metal-ligand complex according to the present invention has relatively excellent resistance to impurities such as oxygen and moisture, and may produce a high molecular weight ethylene-based polymer at a high polymerization temperature.

That is, when the catalyst composition containing a metal-ligand complex according to the present invention is used in the preparation of an ethylene-based polymer, that is, an ethylene homopolymer or a copolymer of ethylene and α-olefin, it is possible to efficiently produce an ethylene homopolymer or a copolymer of ethylene and an α-olefin having a high molecular weight with excellent catalytic activity even at a high polymerization temperature of 220° C. or more.

This is due to the structural characteristics of the metal-ligand complex according to the present invention, and the metal-ligand complex according to the present invention has excellent resistance to impurities and excellent thermal stability, such that the metal-ligand complex has excellent copolymerization reactivity with olefins and may produce a high molecular weight ethylene-based polymer in high yield while maintaining high catalytic activity even at a high temperature.

Therefore, the metal-ligand complex of the present invention and the catalyst composition containing the same may be efficiently used for producing an ethylene-based polymer having excellent physical properties.

### MODE FOR THE INVENTION

Hereinafter, the present invention will describe a metal-ligand complex according to the present invention, a catalyst composition for preparing an ethylene-based polymer containing the same, and a preparation method of an ethylene-based polymer using the same, but technical terms and scientific terms used herein have the general meaning understood by those skilled in the art to which the present invention pertains unless otherwise defined, and a description for the known function and configuration obscuring the present invention will be omitted in the following description.

As used herein, the following terms are defined as follows, but are merely exemplary and are not intended to limit the present invention, application, or use.

As used herein, the terms “substituent”, “radical”, “group”, “group”, “moiety”, and “fragment” may be interchangeably used.

As used herein, the term “C_{A}-C_{B}” means “the number of carbon atoms is greater than or equal to A and less than or equal to B”.

As used herein, the term “alkyl” refers to a linear or branched saturated monovalent hydrocarbon radical composed only of carbon and hydrogen atoms. The alkyl may have 1 to 20 carbon atoms, 1 to 10 carbon atoms, 1 to 5 carbon atoms, 5 to 20 carbon atoms, 8 to 20 carbon atoms or 8 to 15 carbon atoms, but the present invention is not limited thereto. Specific examples of the alkyl include, but are not limited to, methyl, ethyl, n-propyl, isopropyl, n-butyl, sec-butyl, i-butyl, t-butyl, pentyl, i-pentyl, methylbutyl, n-hexyl, t-hexyl, methylpentyl, dimethylbutyl, heptyl, ethylpentyl, methylhexyl, dimethylpentyl, n-octyl, t-octyl, dimethylhexyl, ethylhexyl, n-decyl, t-decyl, n-dodecyl, t-dodecyl, etc.

As used herein, the term “aryl” refers to a monovalent organic radical derived from an aromatic hydrocarbon by removal of one hydrogen, and includes a monocyclic or fused ring system containing suitably 4 to 7, preferably 5 or 6 ring atoms in each ring, and even a form in which a plurality of aryls are connected by a single bond. Specific examples of the aryl include, but are not limited to, phenyl, naphthyl, biphenyl, fluorenyl, phenanthrenyl, anthracenyl, triphenylenyl, pyrenyl, chrysenyl, naphthacenyl, etc.

As used herein, the term “alkylaryl” refers to an aryl radical substituted with at least one alkyl, where “alkyl” and “aryl” are as defined above. Specific examples of the alkylaryl include, but are not limited to, tolyl, etc.

As used herein, the term “arylalkyl” refers to an alkyl radical substituted with at least one aryl, where “alkyl” and “aryl” are as defined above. Specific examples of the arylalkyl include, but are not limited to, benzyl, etc.

The present invention relates to a metal-ligand complex having a specific functional group, and provides a metal-ligand complex represented by the following Chemical Formula 1:

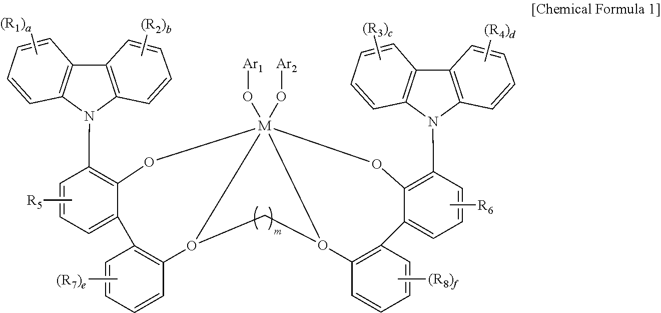

in Chemical Formula 1,
M is a transition metal of Group 4 in the periodic table;
Ar₁ and Ar₂ are each independently C₆-C₂₀aryl, and aryl of Ar₁ and Ar₂ may be further substituted with C₁-C₂₀alkyl;
R₁ to R₄ are each independently C₁-C₂₀alkyl, C₆-C₂₀aryl, or C₆-C₂₀arylC₁-C₂₀alkyl;
R₅ and R₆ are each independently C₁-C₂₀alkyl;
R₇ and R₈ are each independently halogen or C₁-C₂₀alkyl;
a, b, c, d, e, and f are each independently an integer of 0 to 4; and
m is an integer of 2 to 5.

The metal-ligand complex according to an exemplary embodiment introduces an aryloxy group, which is a specific functional group, as a leaving group, so as to increase resistance of a catalyst to impurities such as oxygen and moisture, such that a strong bond between a central transition metal and a ligand is maintained. Therefore, stability of the complex may be significantly improved.

In addition, the metal-ligand complex according to an exemplary embodiment introduces the aryloxy group rather than a methyl group as a leaving group, such that solubility in an organic solvent may be significantly improved, thereby more efficiently improving a polymerization process.

Due to the structural features described above, the metal-ligand complex has not only significantly improved solubility in a hydrocarbon solvent, but also relatively high resistance to impurities and excellent thermal stability, such that the metal-ligand complex may have excellent polymerization reactivity with other olefins while maintaining high catalytic activity even at a high temperature, and may produce a high molecular weight ethylene-based polymer in high yield. Therefore, the metal-ligand complex has high commercial practicability compared to a known metallocene and non-metallocene-based single active site catalyst.

Preferably, according to an exemplary embodiment, in Chemical Formula 1, Ar₁ and Ar₂ may be each independently C₆-C₂₀aryl or C₁-C₂₀alkylC₆-C₂₀aryl; R₁ to R₄ may be each independently C₁-C₂₀alkyl; R₇ and R₈ may be each independently halogen or C₁-C₂₀alkyl; a, b, c, d, e, and f may be each independently an integer of 1 to 3; and m may be an integer of 3 to 5, and more preferably, Ar₁ and Ar₂ may be each independently C₆-C₁₂aryl or C₁-C₂₀alkylC₆-C₁₂aryl; R₁ to R₄ may be each independently C₁-C₁₀alkyl; R₅ and R₆ may be each independently C₁-C₁₀alkyl; R₇ and R₈ may be each independently halogen or C₁-C₁₀alkyl; a, b, c, d, e, and f may be each independently an integer of 1 or 2; and m may be an integer of 3 to 5.

In a specific example, M may be titanium, zirconium, or hafnium.

In a specific example, Ar₁ and Ar₂ may be each independently aryl unsubstituted or substituted with C₁-C₂₀alkyl, where aryl may be phenyl, biphenyl, naphthyl, anthracenyl, pyrenyl, phenanthrenyl, or tetracenyl.

In a specific example, R₁ to R₄ may be each independently branched C₃-C₁₀alkyl, branched C₃-C₇alkyl, or branched C₃-C₄alkyl.

In terms of having more improved resistance, thermal stability, and excellent catalytic activity, preferably, the metal-ligand complex according to an exemplary embodiment may be represented by the following Chemical Formula 2-1 or the following Chemical Formula 2-2:

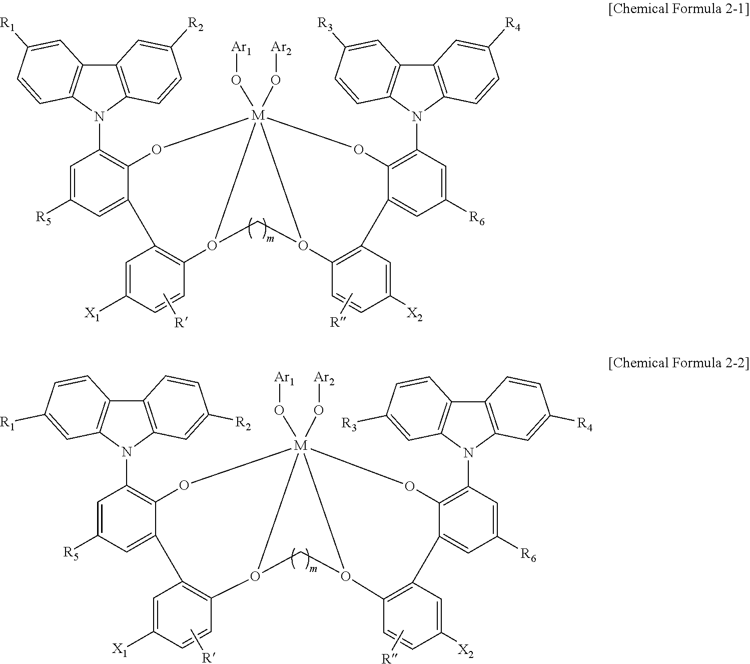

in Chemical Formulas 2-1 and 2-2,
M is titanium, zirconium, or hafnium;
Ar₁ and Ar₂ are each independently C₆-C₂₀aryl or C₁-C₂₀alkylC₆-C₂₀aryl;
R₁ to R₄ are each independently C₁-C₂₀alkyl;
R₅ and R₆ are each independently C₁-C₂₀alkyl;
X₁ and X₂ are each independently halogen;
R′ and R″ are each independently hydrogen or C₁-C₂₀alkyl; and
m is an integer of 3 to 5.

According to an exemplary embodiment, in Chemical Formulas 2-1 and 2-2, Ar₁ and Ar₂ may be each independently C₆-C₁₂aryl or C₁-C₂₀alkylC₆-C₁₂aryl; R₁ to R₄ may be each independently C₁-C₁₀alkyl; R₅ and R₆ may be each independently C₁-C₁₀alkyl; and R′ and R″ may be each independently hydrogen or C₁-C₁₀alkyl; and more preferably, Ar₁ and Ar₂ may be the same as each other and may be C₆-C₁₂aryl or C₁-C₂₀alkylC₆-C₁₂ aryl; R₁ to R₄ may be the same as each other and may be C₁-C₁₀alkyl; R₅ and R₆ may be the same as each other and may be C₁-C₁₀alkyl; and R′ and R″ may be the same as each other and may be hydrogen or C₁-C₁₀alkyl.

In a specific example, R₁ to R₄ may be each independently branched C₃-C₁₀alkyl, branched C₃-C₇alkyl, or branched C₃-C₄alkyl.

More preferably, the metal-ligand complex according to an exemplary embodiment may be represented by the following Chemical Formula 3-1 or the following Chemical Formula 3-2:

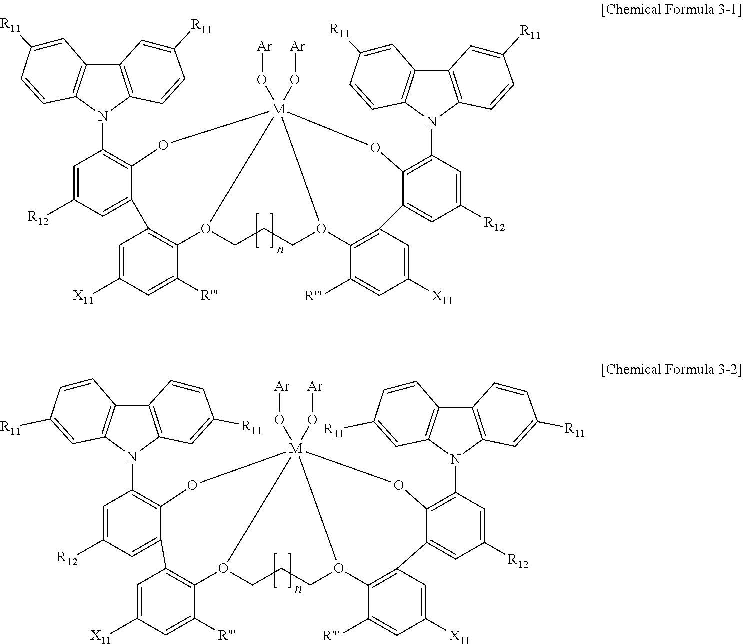

in Chemical Formulas 3-1 and 3-2,
M is zirconium or hafnium;
Ar is C₆-C₁₂aryl or C₁-C₂₀alkylC₆-C₁₂aryl;
R₁₁ is C₁-C₅alkyl;
R₁₂ is C₁-C₁₀alkyl;
X₁₁ is fluoro or chloro;
R″′ is hydrogen or C₁-C₁₀alkyl; and
n is an integer of 1 to 3.

According to an exemplary embodiment, in Chemical Formulas 3-1 and 3-2, Ar may be C₆-C₁₂aryl or C₈-C₂₀alkylC₆-C₁₂aryl; R₁₁ may be C₃-C₅alkyl; R₁₂ may be C₁-C₁₀alkyl; X₁₁ may be fluoro or chloro; R″′ may be hydrogen or C₁-C₅alkyl; and n may be an integer of 1 to 3.

In a specific example, Ru may be branched C₃-C₄alkyl, and specifically, may be t-butyl.

In terms of further improving the high-temperature stability, catalytic activity, and re-activity with olefins, preferably, the metal-ligand complex according to an exemplary embodiment may be represented by the following Chemical Formula 4-1 or the following Chemical Formula 4-2:

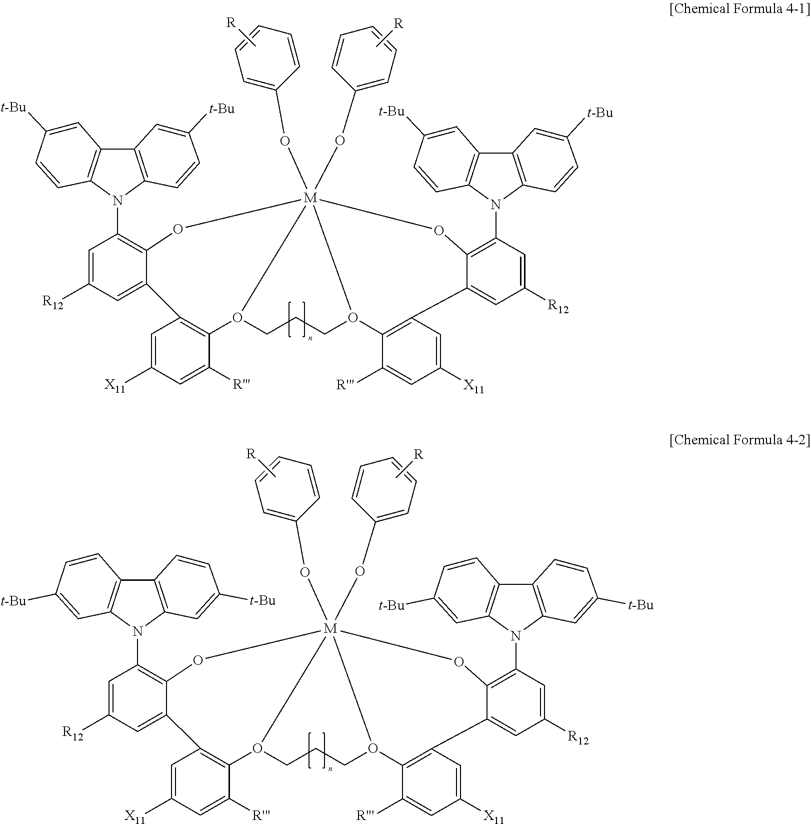

in Chemical Formulas 4-1 and 4-2,
M is zirconium or hafnium;
R is hydrogen or C₈-C₂₀alkyl;
R₁₂ is C₁-C₁₀alkyl;
X₁₁ is fluoro or chloro;
R″′ is hydrogen or C₁-C₁₀alkyl; and
n is an integer of 1 to 3.

In a specific example, R may be hydrogen.

In a specific example, R may be linear or branched C₈-C₂₀alkyl, and specifically, may be n-octyl, t-octyl, n-nonyl, t-nonyl, n-decyl, t-decyl, n-undecyl, t-undecyl, n-dodecyl, t-dodecyl, n-tridecyl, t-tridecyl, n-tetradecyl, t-tetradecyl, n-pentadecyl, or t-pentadecyl.

In a specific example, R′″ may be hydrogen or C₁-C₅alkyl, and specifically, may be hydrogen or methyl.

Specifically, the metal-ligand complex according to an exemplary embodiment may be a compound selected from the following structures, but is not limited to:

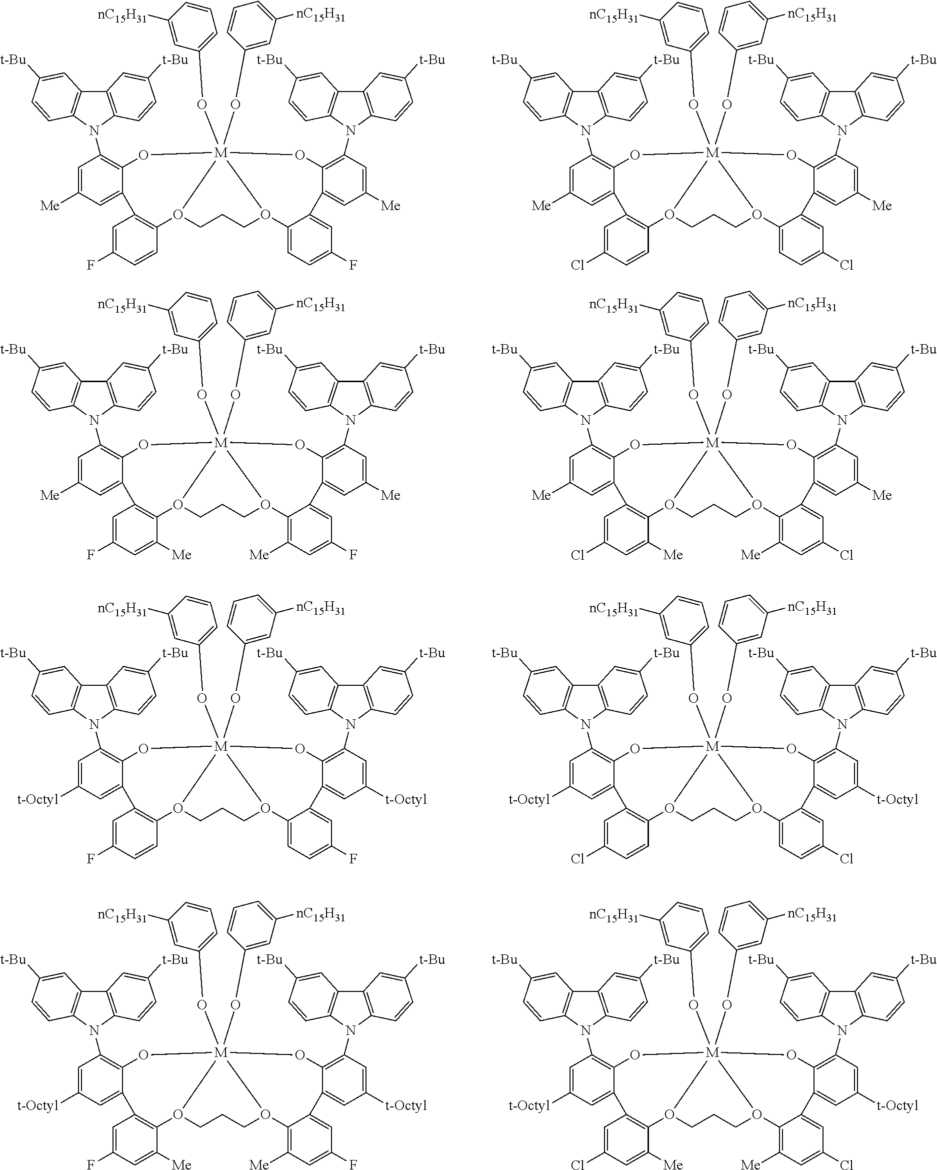

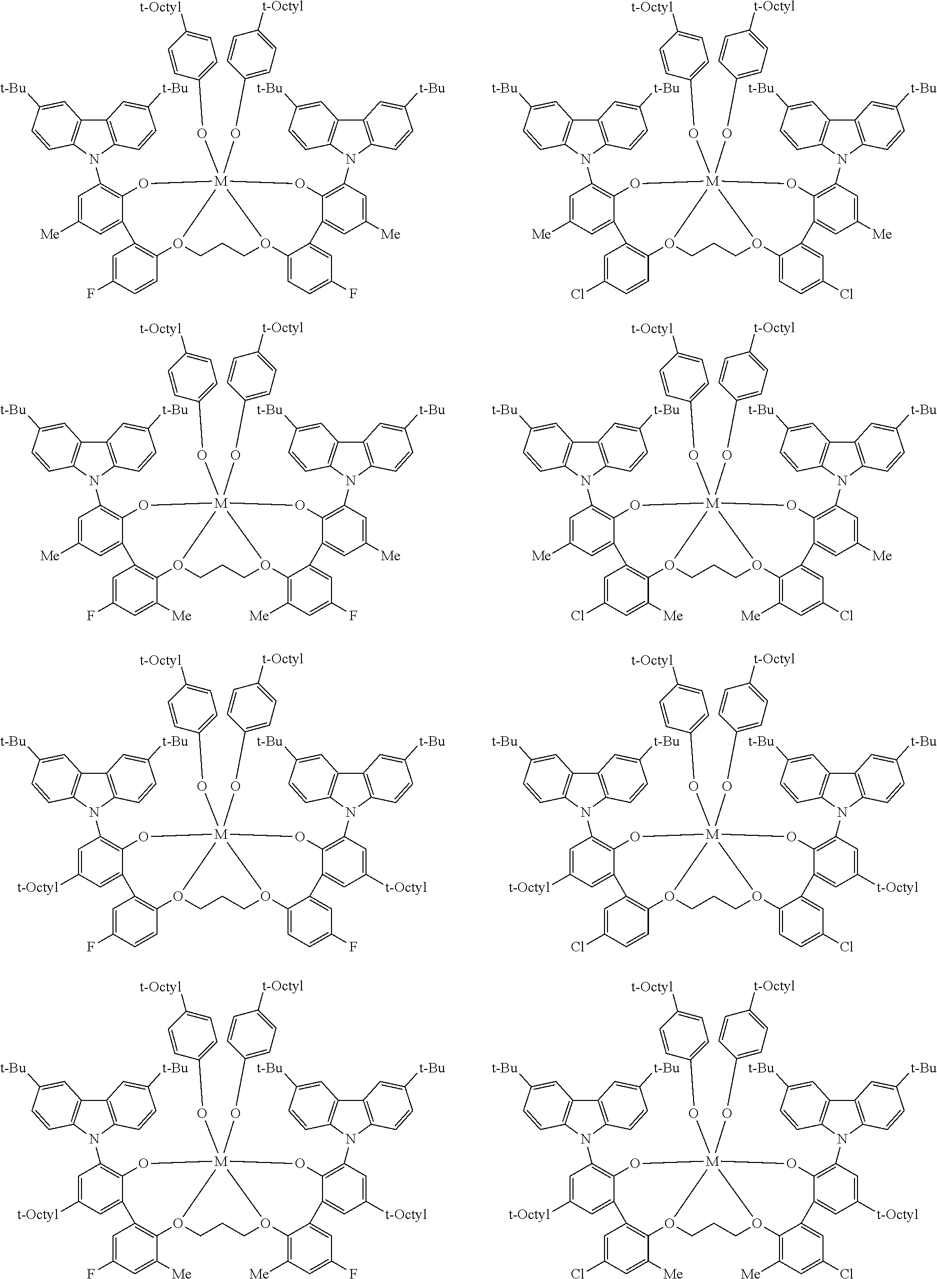

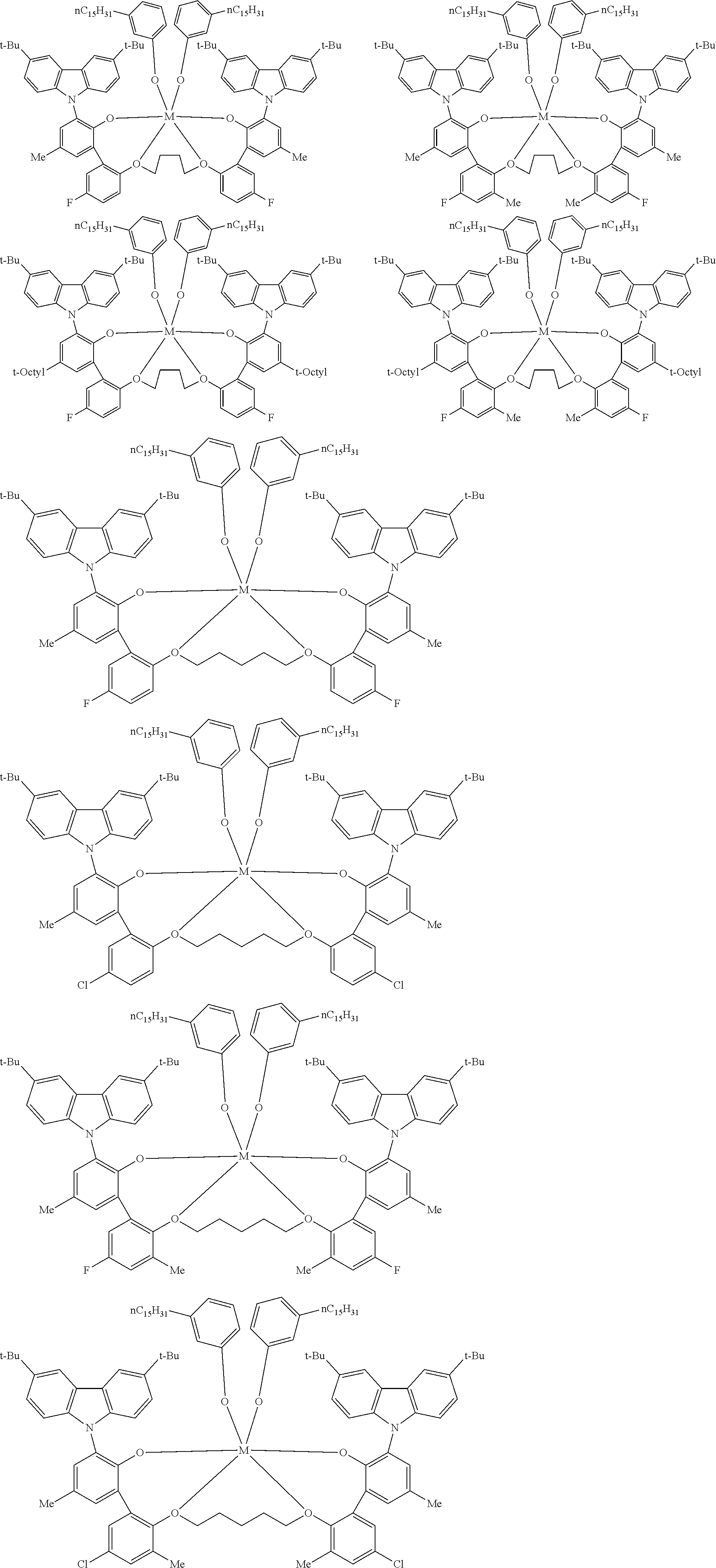

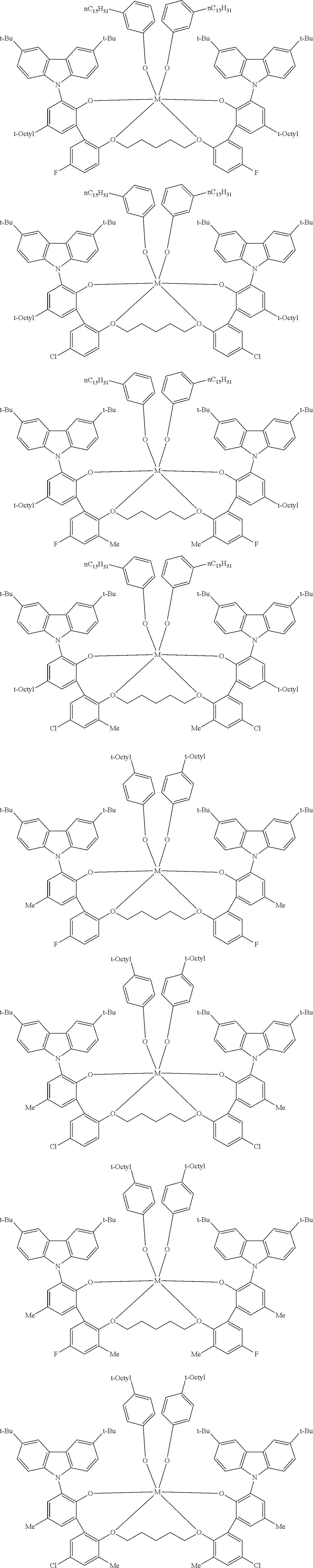

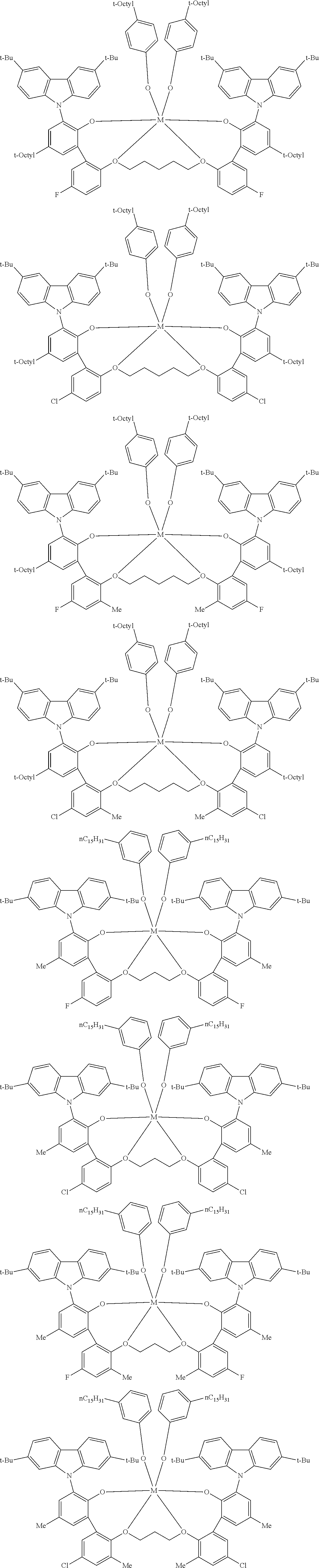

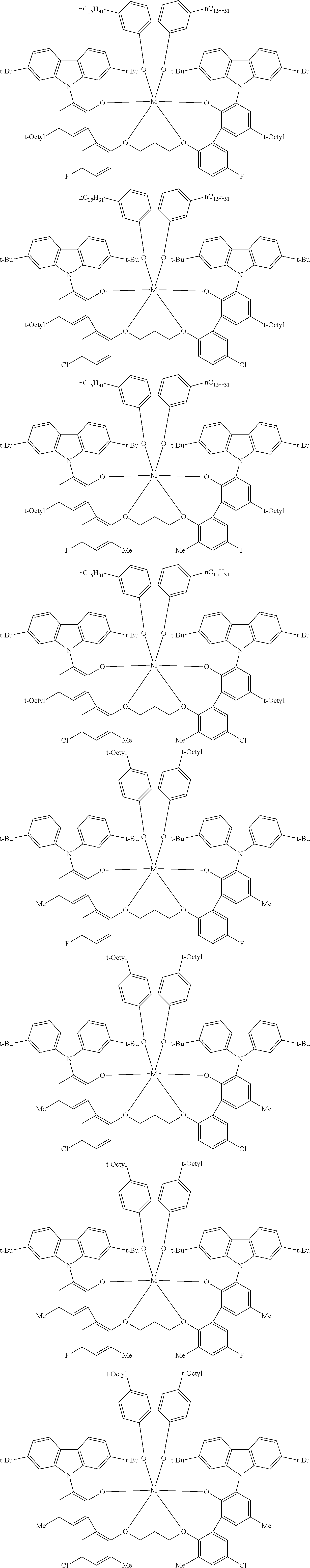

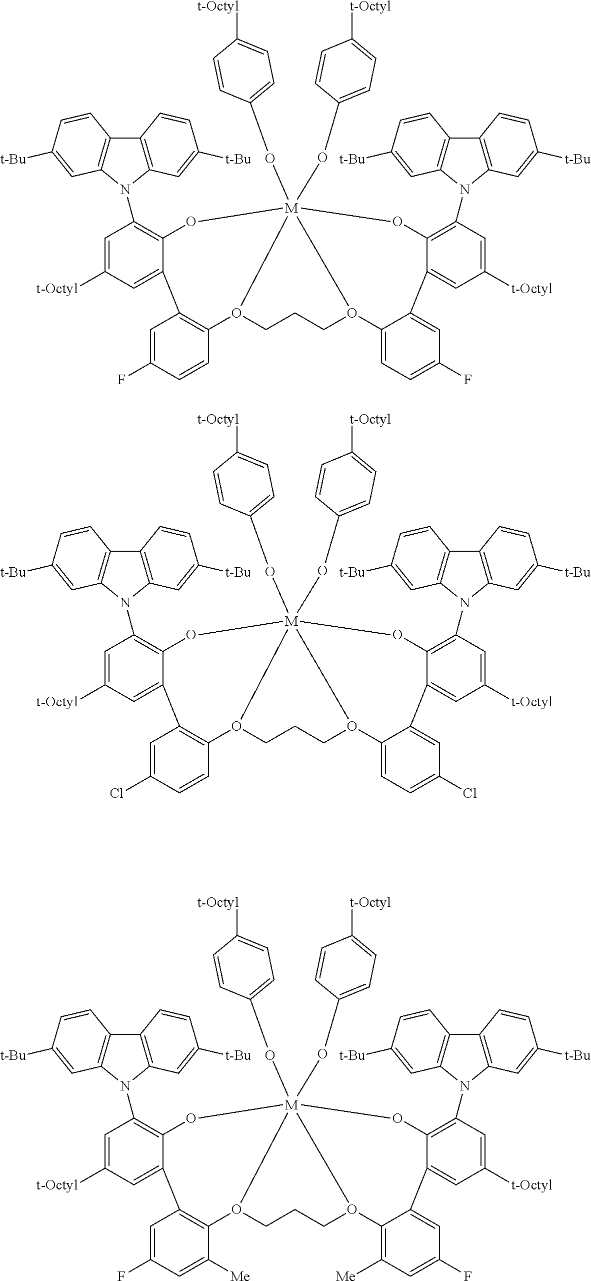

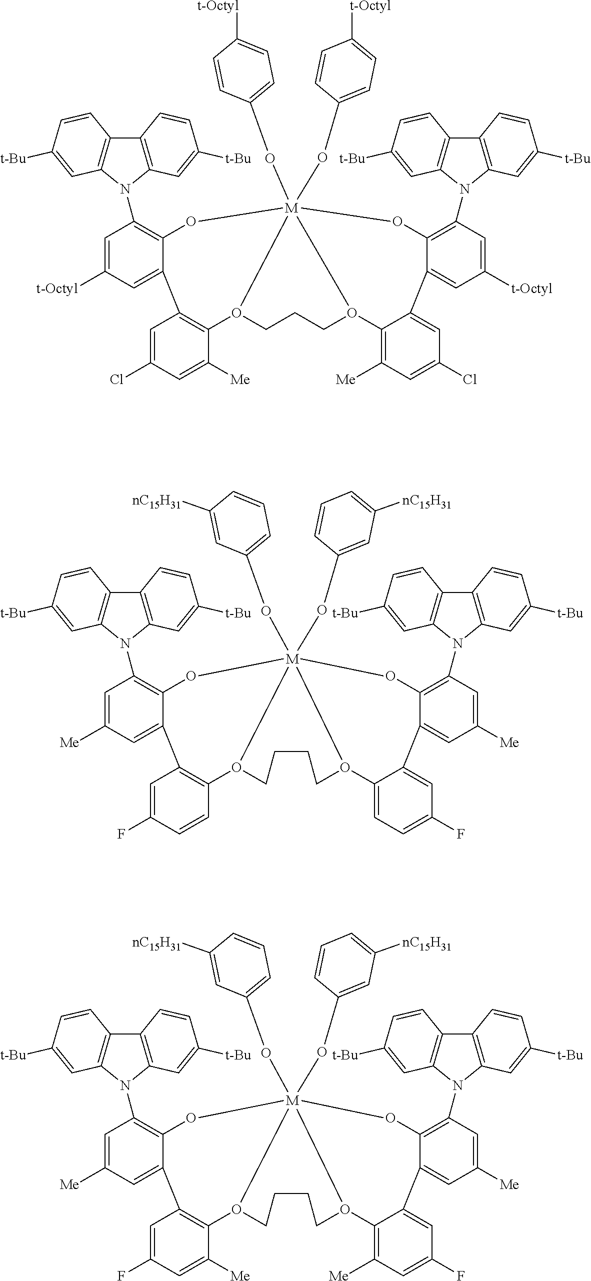

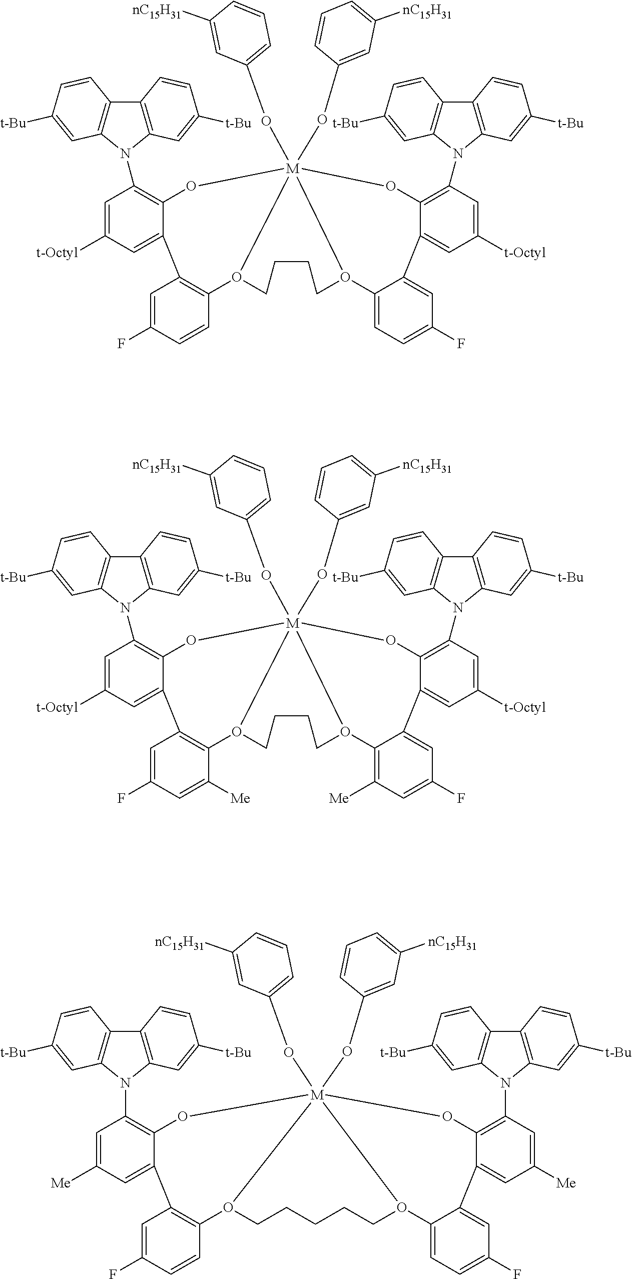

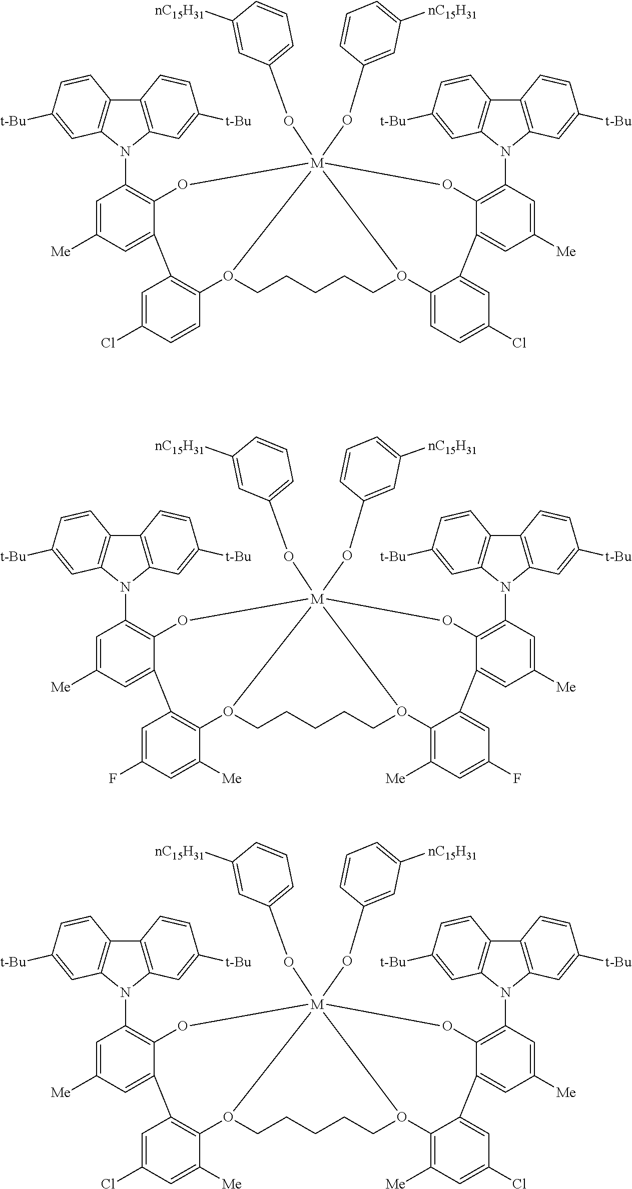

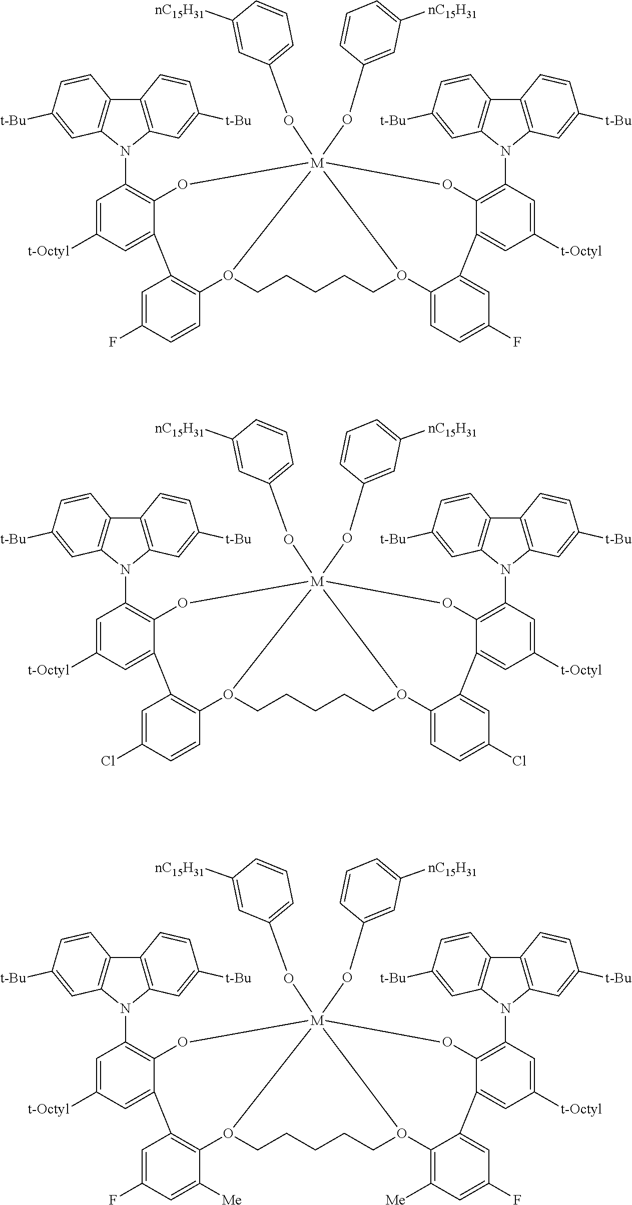

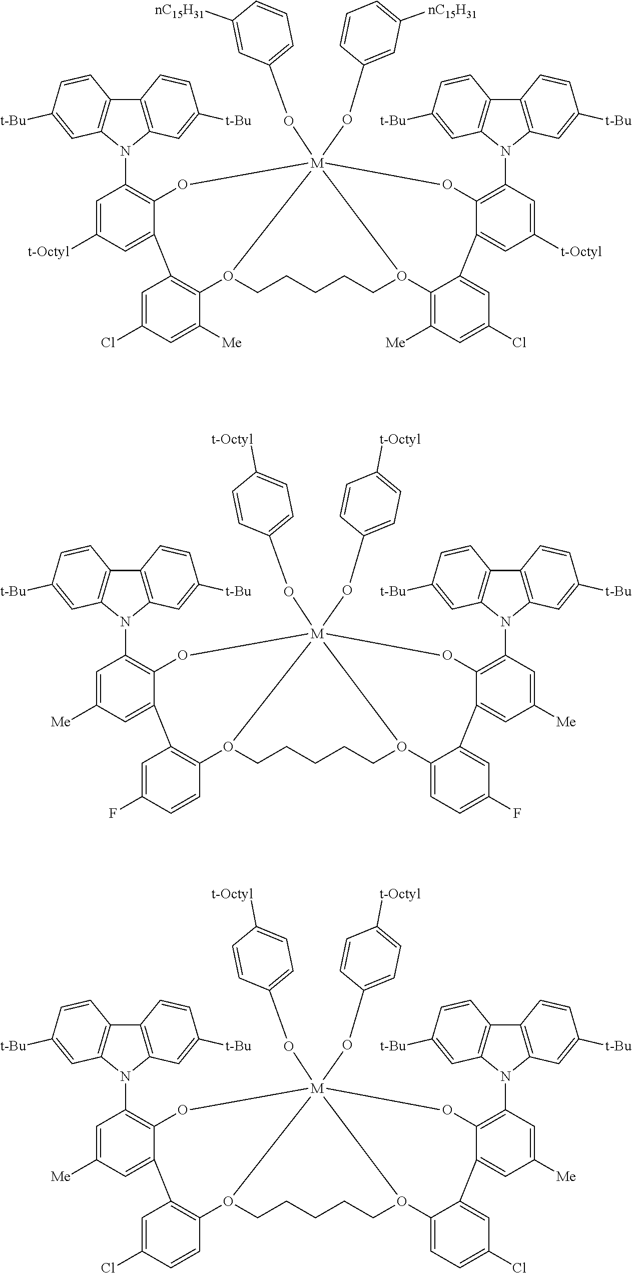

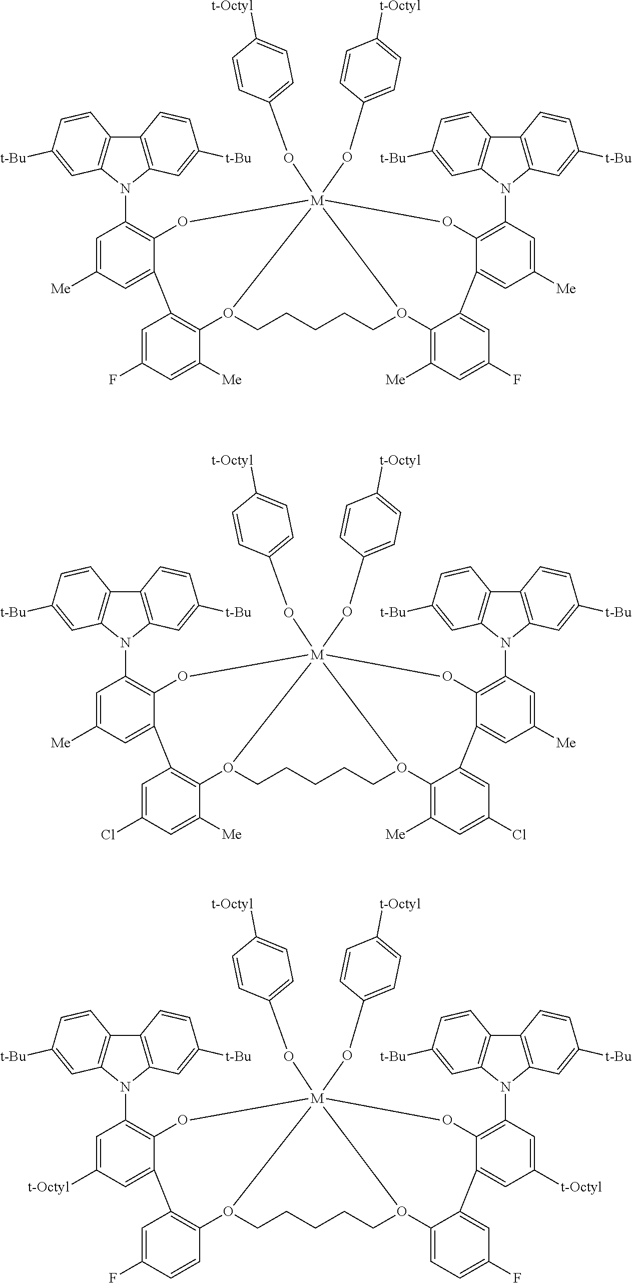

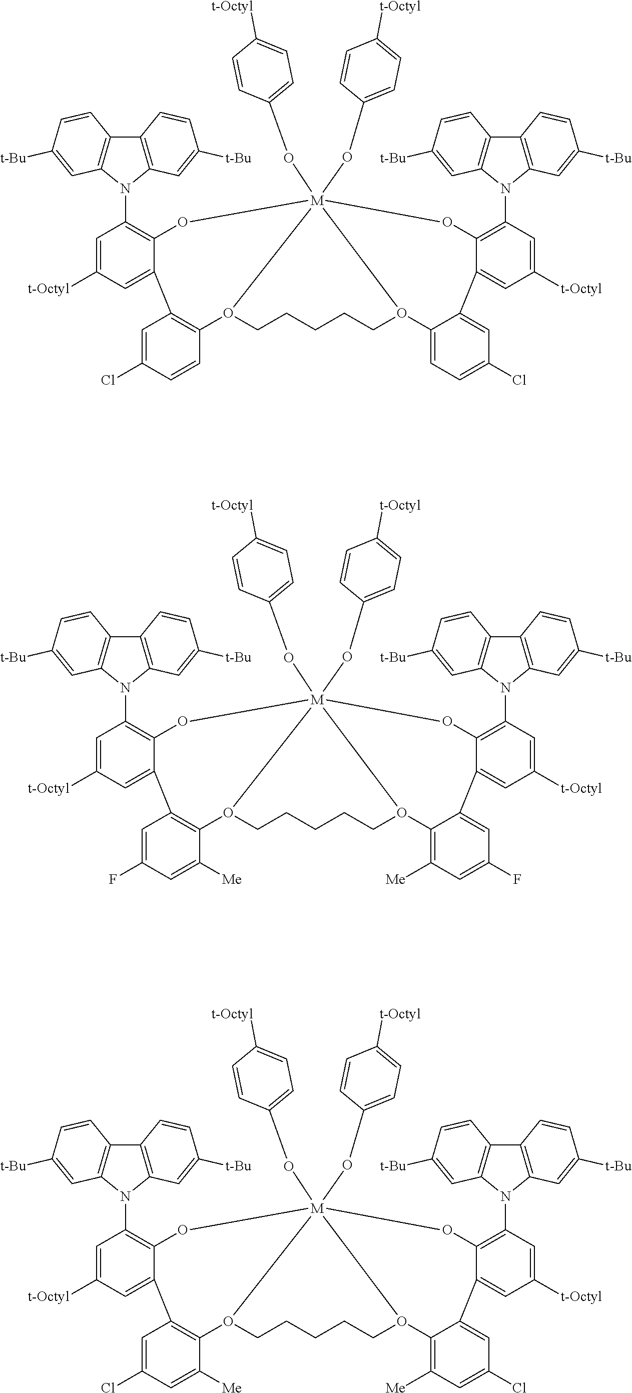

in the above compounds, M is zirconium or hafnium.

In addition, the present invention provides a catalyst composition for preparing an ethylene-based polymer selected from an ethylene homopolymer or a copolymer of ethylene and α-olefin, containing the metal-ligand complex according to the present invention and the cocatalyst.

According to an exemplary embodiment, the cocatalyst may be a boron compound cocatalyst, an aluminum compound cocatalyst, and a mixture thereof.

According to an exemplary embodiment, the cocatalyst may be contained in an amount of 0.5 to 10,000 mol with respect to 1 mol of the metal-ligand complex, but is not limited thereto.

A boron compound that may be used as the cocatalyst may be a boron compound disclosed in U.S. Pat. No. 5,198,401, and specifically, may be one or a mixture of two or more selected from compounds represented by the following Chemical Formulas A to C:

B(R²¹)₃ [Chemical Formula A]

[R²²]⁺[B(R²¹)₄]⁻ [Chemical Formula B]

[(R²³)_{q}ZH]⁺[B(R²¹)₄]⁻ [Chemical Formula C]
in Chemical Formulas A to C,
B is a boron atom; R²¹ is phenyl, and the phenyl may be further substituted with 3 to 5 substituents selected from a fluorine atom, C₁-C₂₀alkyl, C₁-C₂₀alkyl substituted with a fluorine atom, C₁-C₂₀alkoxy, and C₁-C₂₀alkoxy substituted with a fluorine atom; R²² is a C₅-C₇aromatic radical, a C₁-C₂₀alkylC₆-C₂₀aryl radical, or a C₆-C₂₀arylC₁-C₂₀alkyl radical, for example, a triphenylmethylium radical; Z is a nitrogen or phosphorus atom; R²³ is a C₁-C₂₀alkyl radical or an anilinium radical substituted with two C₁-C₁₀alkyls together with a nitrogen atom; and q is an integer of 2 or 3.

The boron-based cocatalyst may be, for example, one or two or more selected from tris(pentafluorophenyl)borane, tris(2,3,5,6-tetrafluorophenyl)borane, tris(2,3,4,5-tetrafluorophenyl)borane, tris(3,4,5-trifluorophenyl)borane, tris(2,3,4-trifluorophenyl)borane, bis(pentafluorophenyl)(phenyl)borane, and the like.

The boron-based cocatalyst may be one or two or more boron compounds having a borate anion selected from the group consisting of tetrakis(pentafluorophenyl)borate, tetrakis(2,3,5,6-tetrafluorophenyl)borate, tetrakis(2,3,4,5-tetrafluorophenyl)borate, tetrakis(3,4,5-trifluorophenyl)borate, tetrakis(2,2,4-trifluorophenyl)borate, tris(pentafluorophenyl)(phenyl)borate, and tetrakis(3,5-bistrifluoromethylphenyl)borate.

The boron-based cocatalyst may be one or two or more boron compounds having a cation selected from the group consisting of triphenylmethylium, triethylammonium, tripropylammonium, tri(n-butyl)ammonium, N,N-dimethylanilinium, N,N-diethylanilinium, N,N-2,4,6-pentamethylanilinium, diisopropylammonium, dicyclohexylammonium, triphenylphosphonium, tri(methylphenyl)phosphonium, and tri(dimethylphenyl)phosphonium.

Specifically, the boron-based cocatalyst may be one or two or more boron compounds having a cation selected from the group consisting of triphenylmethylium, triethylammonium, tripropylammonium, tri(n-butyl)ammonium, N,N-dimethylanilinium, N,N-diethylanilinium, N,N-2,4,6-pentamethylanilinium, diisopropylammonium, dicyclohexylammonium, triphenylphosphonium, tri(methylphenyl)phosphonium, and tri(dimethylphenyl)phosphonium and a borate anion selected from the group consisting of tetrakis(pentafluorophenyl)borate, tetrakis(2,3,5,6-tetrafluorophenyl)borate, tetrakis(2,3,4,5-tetrafluorophenyl)borate, tetrakis(3,4,5-trifluorophenyl)borate, tetrakis(2,2,4-trifluorophenyl)borate, tris(pentafluorophenyl)(phenyl)borate, and tetrakis(3,5-bistrifluoromethylphenyl)borate.

More specifically, the boron-based cocatalyst may be one or two or more selected from the group consisting of triphenylmethylium tetrakis(pentafluorophenyl)borate, triphenylmethylium tetrakis(3,5-bistrifluoromethylphenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(n-butyl)ammonium tetrakis(3,5-bistrifluoromethylphenyl)borate, N,N-dimethylanilinium tetrakis(pentafluorophenyl)borate, N,N-diethylanilinium tetrakis(pentafluorophenyl)borate, N,N-2,4,6-pentamethylanilinium tetrakis(pentafluorophenyl)borate, N,N-dimethylanilinium tetrakis(3,5-bistrifluoromethylphenyl)borate, diisopropylammonium tetrakis(pentafluorophenyl)borate, dicyclohexylammonium tetrakis(pentafluorophenyl)borate, triphenylphosphonium tetrakis(pentafluorophenyl)borate, tri(methylphenyl)phosphonium tetrakis(pentafluorophenyl)borate, and tri(dimethylphenyl)phosphonium tetrakis(pentafluorophenyl)borate, and more preferably, one or two or more selected from the group consisting of triphenylmethylinium tetrakis(pentafluorophenyl)borate, N,N-dimethylanilinium tetrakis(pentafluorophenyl)borate, and tris(pentafluorophenyl)borane.

Examples of an aluminum compound that may be used as the cocatalyst in the catalyst composition according to an exemplary embodiment of the present invention include an aluminoxane compound of Chemical Formula D or E, an organoaluminum compound of Chemical Formula F, and an organoaluminum alkyloxide or organoaluminum aryloxide compound of Chemical Formula G or H:

(—Al(R³¹)—O—)ᵣ [Chemical Formula D]

(R³¹)₂Al—(—O(R³¹)—)ₛ—(R³¹)₂ [Chemical Formula E]

(R³²)ₜAl(E)₃₋ₜ [Chemical Formula F]

(R³³)₂AlOR³⁴ [Chemical Formula G]

R³³Al(OR³⁴)₂ [Chemical Formula H]
in Chemical Formulas D to H,
R³¹ is C₁-C₂₀alkyl and preferably methyl or isobutyl; r and s are each independently an integer of 5 to 20; R³² and R³³ are each independently C₁-C₂₀alkyl; E is a hydrogen atom or a halogen atom; t is an integer of 1 to 3; and R³⁴ is C₁-C₂₀alkyl or C₆-C₃₀aryl.

Specific examples of a compound that may be used as the aluminum compound include aluminoxane compounds such as methylaluminoxane, modified methylaluminoxane, and tetraisobutyldialuminoxane; and organoaluminum compounds, for example, trialkylaluminum including trimethylaluminum, triethylaluminum, tripropylaluminum, triisobutylaluminum, and trihexylaluminum, dialkylaluminum chloride including dimethylaluminum chloride, diethylaluminum chloride, dipropylaluminum chloride, diisobutylaluminum chloride, and dihexylaluminum chloride, alkylaluminum dichloride including methylaluminum dichloride, ethylaluminum dichloride, propylaluminum dichloride, isobutylaluminum dichloride, and hexylaluminum dichloride, dialkylaluminum hydride including dimethylaluminum hydride, diethylaluminum hydride, dipropylaluminum hydride, diisobutylaluminum hydride, and dihexylaluminum hydride, and alkylalkoxyaluminum including methyldimethoxyaluminum, dimethylmethoxyaluminum, ethyldiethoxyaluminum, diethylethoxyaluminum, isobutyldibuthoxyaluminum, diisobutylbutoxyaluminum, hexyldimethoxyaluminum, dihexylmethoxyaluminum, and dioctylmethoxyaluminum. Preferably, an aluminoxane compound, trialkylaluminum, and a mixture thereof may be used as the cocatalyst. Specifically, methylaluminoxane, modified methylaluminoxane, tetraisobutyldialuminoxane, trimethylaluminum, triethylaluminum, and triisobutylaluminum may be used alone or in a mixture thereof. More preferably, tetraisobutyldialuminoxane, triisobutylaluminum, and a mixture thereof may be used.

Preferably, in the catalyst composition according to an exemplary embodiment of the present invention, when the aluminum compound is used as a cocatalyst, a ratio between the transition metal (M):the aluminum atom (Al) in the metal-ligand complex according to the present invention and the aluminum compound cocatalyst may be preferably in the range of 1:10 to 10,000 based on the molar ratio.

Preferably, in the catalyst composition according to an exemplary embodiment of the present invention, when both the aluminum compound and the boron compound are used as cocatalysts, a ratio of transition metal (M):boron atom (B):aluminum atom (Al) in the metal-ligand complex according to the present invention and the cocatalyst may be in the range of 1:0.1 to 200:10 to 10,000, and more preferably in the range of 1:0.5 to 100:25 to 5,000 based on the molar ratio.

The ratio between the metal-ligand complex according to the present invention and the cocatalyst exhibits excellent catalytic activity for preparing an ethylene-based polymer within the above range, and the range of the ratio varies depending on the purity of the reaction.

As another aspect according to an exemplary embodiment of the present invention, the preparation method of an ethylene-based polymer using the catalyst composition for preparing an ethylene-based polymer may be carried out by contacting the metal-ligand complex, a cocatalyst, and ethylene or, if necessary, a comonomer in the presence of an appropriate organic solvent. In this case, a precatalyst, which is the metal-ligand complex, and the cocatalyst component may be separately injected into a reactor, or may be injected into the reactor by mixing each component in advance, and there is no limitation on mixing conditions such as the order of introduction, temperature, or concentration.

A preferred organic solvent that may be used in the production method is a C3-C20 hydrocarbon, and specific examples thereof include n-butane, isobutane, n-pentane, n-hexane, n-heptane, n-octane, isooctane, nonane, decane, dodecane, cyclohexane, methylcyclohexane, benzene, toluene, and xylene.

Specifically, when an ethylene homopolymer is produced, ethylene is used alone as a monomer, and when a copolymer of ethylene and α-olefin is produced, C3 to C18 α-olefin may be used as a comonomer together with ethylene. Specific examples of the C3 to C18 α-olefin include propylene, 1-butene, 1-pentene, 4-methyl-1-pentene, 1-hexene, 1-octene, 1-decene, 1-dodecene, 1-hexadecene, 1-octadecene, etc. In the present invention, the C3 to C18 α-olefin as described above may be homopolymerized with ethylene, or two or more types of olefins may be copolymerized, and more preferably, 1-butene, 1-hexene, 1-octene, or 1-decene may be copolymerized with ethylene.

The pressure of ethylene may be 1 to 1,000 atm, and more preferably 5 to 100 atm. In addition, the polymerization reaction is effectively performed at a temperature of 80° C. or higher, preferably 100° C. or higher, and more preferably 160° C. to 250° C. Temperature and pressure conditions in the polymerization process may be determined in consideration of the efficiency of the polymerization reaction according to the type of reaction and the type of reactor to be applied.

In general, when the solution polymerization process is performed at a high temperature as described above, it is difficult to obtain a polymer having desired physical properties because the catalyst is deformed or deteriorated as the temperature rises and the activity of the catalyst is thus lowered. However, when an ethylene-based polymer is produced using the catalyst composition according to the present invention, stable catalytic activity is exhibited at a high polymerization temperature.

The ethylene-based polymer is an ethylene homopolymer or a copolymer of ethylene and an α-olefin. The copolymer of ethylene and an α-olefin contains 50 wt % or more of ethylene, preferably 60 wt % or more of ethylene, and more preferably 60 to 99 wt % of ethylene.

As described above, linear low density polyethylene (LLDPE) produced using a C4 to C10 α-olefin as a comonomer has a density range of 0.940 g/cc or less, and may be extended to the range of very low density polyethylene (VLDPE) or ultra-low density polyethylene (ULDPE) having a density of 0.900 g/cc or less or an olefin elastomer. In addition, when an ethylene copolymer according to the present invention is produced, hydrogen may be used as a molecular weight regulator for adjusting the molecular weight, and the ethylene copolymer usually has a weight average molecular weight (Mw) of 80,000 to 500,000.

Since the catalyst composition presented in the present invention is present in a homogeneous form in a polymerization reactor, it is preferred to apply to a solution polymerization process which is carried out at a temperature equal to or more than a melting point of the polymer. However, as disclosed in U.S. Pat. No. 4,752,597, the catalyst composition may be used in a slurry polymerization or gas phase polymerization process in the form of a heterogeneous catalyst composition obtained by supporting the precatalyst, which is the metal-ligand complex, and the cocatalyst, on a porous metal oxide support.

Hereinafter, the present invention will be described in detail by the following examples, however, the scope of the present invention is not limited thereto.

Unless otherwise stated, all experiments of synthesizing ligands and catalysts were carried out using a standard Schlenk or glove box technology under a nitrogen atmosphere, and an organic solvent used in the reaction was refluxed under a sodium metal and benzophenone to remove moisture, and used after being distilled immediately before use. The ¹H-NMR analysis of the synthesized ligand and catalyst was carried out using Bruker 400 or 500 MHz at room temperature.

Methylcyclohexane and n-heptane, which are polymerization solvents, were used after being passed through a tube filled with a 5 Å molecular sieve and activated alumina and bubbling with high-purity nitrogen to sufficiently remove moisture, oxygen and other catalyst poison substances.

### COMPARATIVE EXAMPLE 1

### Synthesis of Precatalyst C1

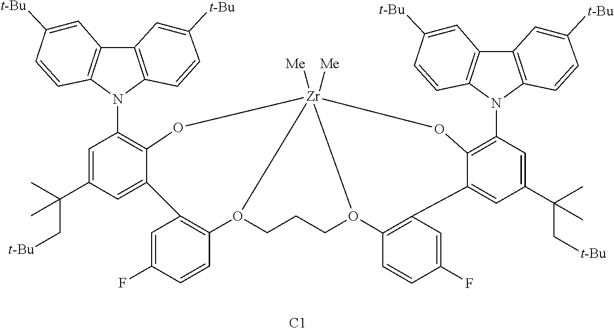

A precatalyst C1 was prepared using 4-tert-octylphenol and 3,6-di-tert-butyl-9H-carbazole according to KR 10-2018-0048728 A and KR 10-2019-0075778 A.

### EXAMPLE 1

### Synthesis of Precatalyst C2

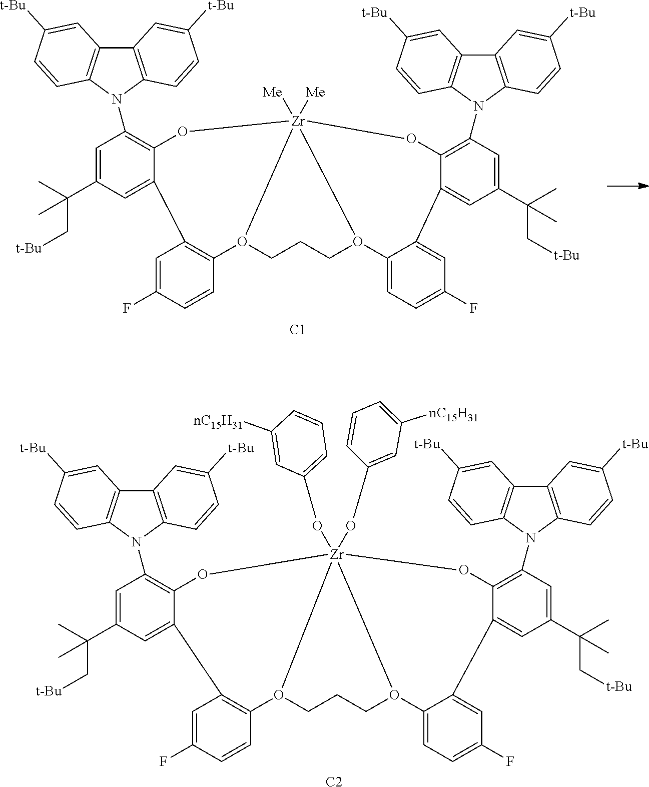

The reaction was performed in a glove box under a nitrogen atmosphere. A pre-catalyst C1 (1.17 g, 0.87 mmol) and toluene (40 mL) were added to a 100 ml flask, 3-pentadecylphenol (0.53 g, 1.74 mmol) was added to the flask, the mixture was stirred at room temperature for 2 hours, and then a solvent was removed. The mixture was dissolved in 50 mL of n-hexane, and then a solid was removed by filtration with a filter filled with dried celite. The filtered solution was vacuum-dried to obtain precatalyst C2 as a white solid (1.52 g, 91%).

¹H NMR (CDCl₃): δ 8.40 (s, 2H), 8.28 (s, 2H), 7.53-7.00 (m, 14H), 6.72 (m, 2H), 6.64 (m, 2H), 6.36 (m, 2H), 5.89 (m, 2H), 5.60 (s, 2H), 4.99 (m, 2H), 4.70 (m, 2H), 4.12 (m, 2H), 3.65 (m, 2H), 2.32 (m, 4H), 1.73 (s, 4H) 1.59-0.81 (124H).

### EXAMPLE 2

### Synthesis of Precatalyst C3

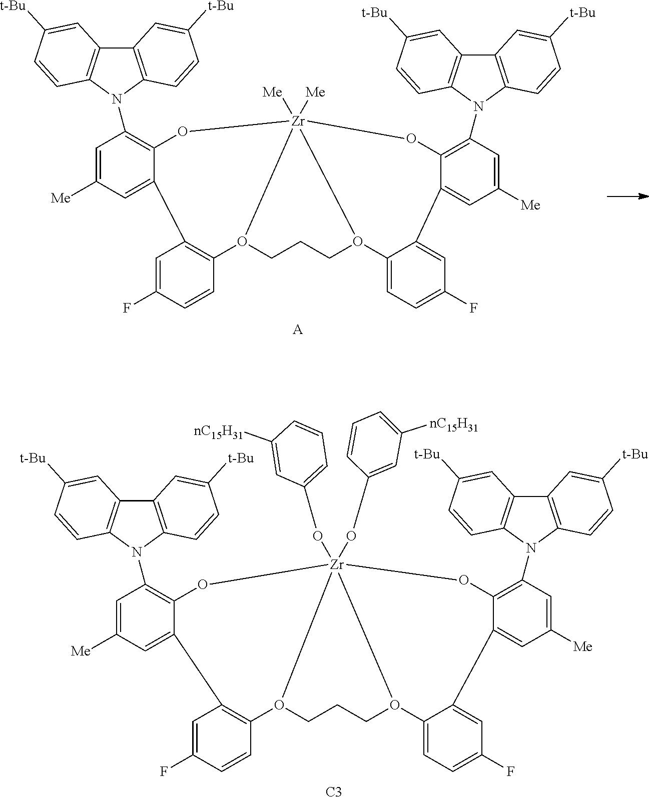

A precatalyst A was prepared in the same manner as that of Comparative Example 1, except that 4-methylphenol was used instead of 4-tert-octylphenol.

¹H NMR (CDCl₃): δ 8.30 (s, 2H), 8.07 (s, 2H), 7.47-7.00 (m, 16H), 6.27 (m, 2H), 4.60 (m, 2H), 3.80 (m, 2H), 3.40 (m, 2H), 2.34 (s, 6H), 1.54 (s, 18H), 1.38 (s, 18H), −1.50 (s, 6H).

A precatalyst C3 (white solid, 1.36 g, 90%) was prepared in the same manner as that of Example 1, except that the precatalyst A was used instead of the precatalyst C1.

¹H NMR (CDCl₃): δ 8.36 (s, 2H), 8.25 (s, 2H), 7.44-7.00 (m, 14H), 6.72 (m, 2H), 6.60 (m, 2H), 6.33 (m, 2H), 5.85 (m, 2H), 5.58 (s, 2H), 4.94 (m, 2H), 4.67 (m, 2H), 4.15 (m, 2H), 3.69 (m, 2H), 2.32 (s, 6H), 2.30 (m, 4H), 1.56-1.26 (m, 52H), 1.51 (s, 18H), 1.40 (s, 18H), 0.90 (m, 6H).

### EXAMPLE 3

### Synthesis of Precatalyst C4

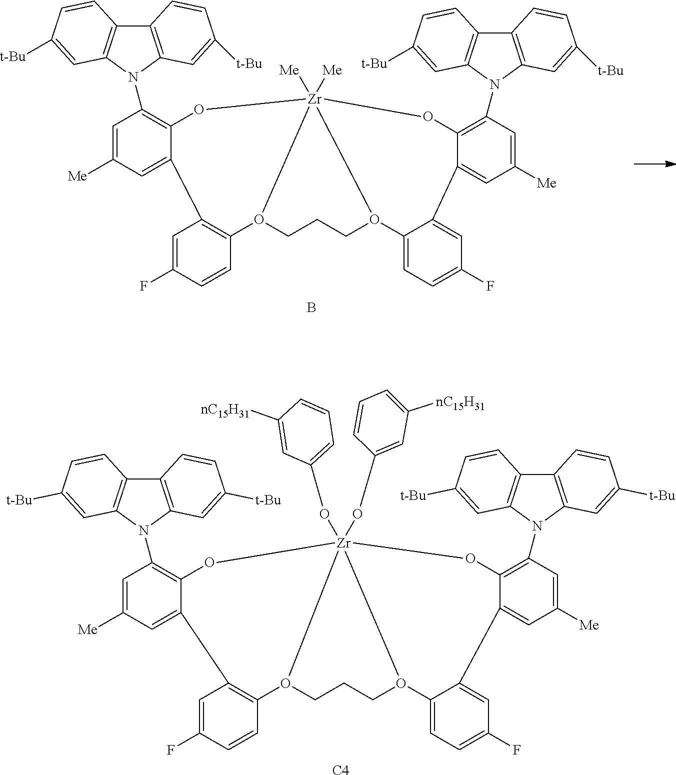

A precatalyst B was prepared in the same manner as that of Comparative Example 1, except that 4-methylphenol was used instead of 4-tert-octylphenol, and 2,7-di-tert-butyl-9H-carbazole was used instead of 3,6-di-tert-butyl-9H-carbazole.

A precatalyst C4 (white solid, 0.58 g, 70%) was prepared in the same manner as that of Example 1, except that the precatalyst B was used instead of the precatalyst C1.

¹H NMR (CDCl₃): δ 8.31 (d, 2H), 8.25 (s, 2H), 7.44-7.00 (m, 8H), 6.98-6.96 (m, 2H), 6.92-6.91 (m, 2H), 6.75 (m, 4H), 6.51 (m, 2H), 5.84 (m, 2H), 5.38 (m, 2H), 5.23 (m, 2H), 4.84 (m, 2H), 4.24-4.22 (m, 2H), 3.81-3.80 (m, 2H), 2.32 (s, 6H), 1.94-1.93 (m, 2H), 1.51 (m, 92H), 1.08 (m, 6H).

### EXAMPLE 4

### Copolymerization of Ethylene and 1-Octene for Measurement of Oxygen Sensitivity of Produced Transition Metal Compound

10 μmol of the precatalyst C2 prepared in Example 1 was exposed to the air at 22.1° C. and humidity of 31% for about 1 hour, a saturated solution was prepared by dissolving the precatalyst C2 in 10 ml of toluene, and then copolymerization of ethylene and 1-octene was performed using a batch polymerization apparatus as follows.

600 mL of methylcyclohexane and 50 mL of 1-octene were injected into a stainless-steel reactor having a capacity of 1,500 mL, the inside of which was purged with nitrogen after sufficient drying, and then 2 mL of a triisobutylaluminum 1.0 M hexane solution was added to the reactor. Thereafter, the temperature of the reactor was heated to 100° C., 1 ml of a saturated solution of the precatalyst C2 (that is, a saturated solution containing 1.0 μmol of the precatalyst C2 in 1 ml of toluene) and 40 μmol of triphenyl-methylium tetrakis(pentafluorophenyl)borate were sequentially added, the reactor was filled with ethylene to result in a pressure of 20 bar, and then ethylene was continuously supplied to allow polymerization. The reaction was performed for 5 minutes, and then the recovered reaction product was dried in a vacuum oven at 40° C. for 8 hours. The polymerization results are shown in Table 1.

### EXAMPLE 5

Copolymerization of ethylene and 1-octene was performed in the same manner as that of Example 4, except that the precatalyst C2 (Example 1) not exposed to the air was used. The polymerization reaction conditions and the polymerization results are shown in Table 1.

### COMPARATIVE EXAMPLE 2

Copolymerization of ethylene and 1-octene was performed in the same manner as that of Example 4, except that the precatalyst C1 (Comparative Example 1) was used instead of the precatalyst C2 (Example 1). The polymerization reaction conditions and the polymerization results are shown in Table 1.

### COMPARATIVE EXAMPLE 3

Copolymerization of ethylene and 1-octene was performed in the same manner as that of Example 4, except that the precatalyst C1 (Comparative Example 1) not exposed to the air was used instead of the precatalyst C2 (Example 1). The polymerization reaction conditions and the polymerization results are shown in Table 1.

TABLE 1

| | | | | Catalytic |
|---|---|---|---|---|
| | | | | activity |
| | | Whether or not | | (kg/amount |
| | Metal-ligand | precatalyst is | ΔT | of catalyst |
| Polymerization | complex | exposed to air | (° C.) | used mmol) |
| Example 4 | Precatalyst C2 | ◯ | 37.8 | 27.1 |
| | (Example 1) | | | |
| Example 5 | Precatalyst C2 | X | 38.6 | 29.1 |
| | (Example 1) | | | |
| Comparative | Precatalyst C1 | ◯ | 2.1 | 2.2 |
| Example 2 | (Comparative | | | |
| | Example 1) | | | |
| Comparative | Precatalyst C1 | X | 33.6 | 28.1 |
| Example 3 | (Comparative | | | |
| | Example 1) | | | |

Polymerization catalyst:triphenylmethylium tetrakis(pentafluorophenyl)borate:triisobutyl aluminum molar ratio = 1:40:2000

Table 1 shows the results of observing the temperature change (ΔT) of the precatalyst C2 of Example 1 and the precatalyst C1 of Comparative Example 1, which are used as the catalyst in the polymerization of ethylene and 1-octene, depending on whether or not the precatalyst is exposed to the air. From the results, it could be confirmed that the precatalyst C2 of Example 1 showed a constant temperature change during polymerization regardless of whether or not it was exposed to the air, whereas the precatalyst C1 of Comparative Example 1 showed a significantly reduced temperature change as it was exposed to the air.

Specifically, from the polymerization results of Table 1, it may be appreciated that since the precatalyst C2 (Example 1) of the present invention has a structure in which an alkyl-substituted phenoxy-based leaving group such as pentadecyl is introduced, unlike the precatalyst C1 (Comparative Example 1) in which an alkyl-based leaving group such as methyl is introduced, the precatalyst C2 is relatively less sensitive to impurities such as oxygen and moisture in the air, and the resulting decrease in activity, that is, the effect on impurities that may appear during the reaction is relatively small, such that the stability of the catalyst is excellent, which may be advantageous in commercial plant applications.

As described above, it can be confirmed that resistance to impurities, such as oxygen and moisture, and stability and activity of the catalyst are remarkably changed due to the structure of the polymerization catalyst.

### EXAMPLES 6 to 8 AND COMPARATIVE EXAMPLE 4

### Copolymerization of Ethylene and 1-Octene at High Temperature by Continuous Solution Polymerization Process

Copolymerization of ethylene and 1-octene was performed in a temperature-controlled continuous polymerization reactor equipped with a mechanical stirrer.

The precatalysts C2, C3, C4 and C1 prepared in Examples 1, 2 and 3 and Comparative Example 1 were used as catalysts, and n-heptane was used as a solvent, and modified methylaluminoxane (20 wt %, Nouryon) was used as a cocatalyst. The amounts of catalysts used are as shown in Table 2. Each catalyst was dissolved in toluene at a concentration of 0.2 g/L and then injected, and polymerization was performed using 1-octene as a comonomer. A conversion rate of the reactor was estimated through the reaction conditions and the temperature gradient in the reactor when polymerization was performed with only one kind of polymer under each of the reaction conditions. A molecular weight was controlled as a function of reactor temperature and 1-octene content in the case of a single active site catalyst. The conditions and results are shown in Table 2.

Melt index (MI): A melt index (MI) was measured at 190° C. and a load of 2.16 kg using ASTM D1238 analysis method.

Density: A density was measured by ASTM D792 analysis method.

TABLE 2

| | | | | | Comparative |
|---|---|---|---|---|---|
| | | Example 6 | Example 7 | Example 8 | Example 4 |
| Polymerization | Precatalyst | C2 | C3 | C4 | C1 |
| condition | | (Example 1) | (Example 2) | (Example 3) | (Comparative |
| | | | | | Example 1) |
| | Total solution | 5 | 5 | 5 | 5 |
| | flow rate (kg/h) | | | | |
| | Amount of | 10 | 10 | 10 | 10 |
| | ethylene | | | | |
| | added(wt %) | | | | |
| | Molar ratio | 1.3 | 1.3 | 1.3 | 1.3 |
| | of added | | | | |
| | 1-octene to | | | | |
| | added ethylene | | | | |
| | (1-C8/C2) | | | | |
| | Amount of | 0.6 | 0.5 | 0.45 | 1.55 |
| | Zr added | | | | |
| | (μmol/kg) | | | | |
| | Amount of | 800 | 800 | 1000 | 1000 |
| | Al added | | | | |
| | (μmol/kg) | | | | |
| | Reaction | 220 | 220 | 220 | 220 |
| | temperature | | | | |
| | (° C.) | | | | |
| Polymerization | Ethylene | 76 | 76 | 76 | 76 |
| result | conversion | | | | |
| | rate (%) | | | | |
| | MI | 9.64 | 5.81 | 3.0 | 9.76 |
| | Density (g/cc) | 0.9054 | 0.8999 | 0.921 | 0.9044 |

Zr: refers to Zr in the precatalyst.
Al: refers to Al in cocatalyst modified methylaluminoxane.

From the polymerization results of Table 2, it could be appreciated that in the case of Examples 6, 7 and 8 using the precatalyst C2 (Example 1), the precatalyst C3 (Example 2) and the precatalyst C4 (Example 3) of the present invention as the polymerization catalysts, excellent activity was maintained despite the reduced amount of catalyst at a high temperature of 220° C., compared to the case of Comparative Example 4 using the known precatalyst C1 (Comparative Example 1), and the catalytic activity was significantly improved compared to the existing catalyst.

Therefore, it may be appreciated that the metal-ligand complex according to the present invention may effectively produce a copolymer of high molecular weight ethylene and an α-olefin with significantly excellent catalytic activity and stability even at a high temperature due to the structural characteristics of introducing a specific functional group.

1. A metal-ligand complex represented by the following Chemical Formula 1: 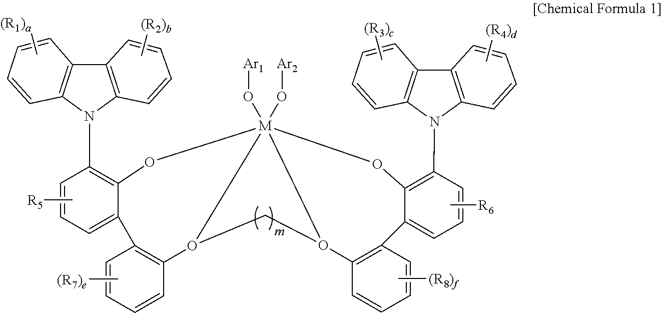
in Chemical Formula 1,
M is a transition metal of Group 4 in the periodic table;
Ar₁ and Ar₂ are each independently C₆-C₂₀aryl, and aryl of Ar₁ and Ar₂ may be further substituted with C₁-C₂₀alkyl;
R₁ to R₄ are each independently C₁-C₂₀alkyl, C₆-C₂₀aryl, or C₆-C₂₀arylC₁-C₂₀alkyl;
R₅ and R₆ are each independently C₁-C₂₀alkyl;
R₇ and R₈ are each independently halogen or C₁-C₂₀alkyl;
a, b, c, d, e, and f are each independently an integer of 0 to 4; and
m is an integer of 2 to 5.

2. The metal-ligand complex of claim 1, wherein
Ar₁ and Ar₂ are each independently C₆-C₂₀aryl or C₁-C₂₀alkylC₆-C₂₀aryl;
R₁ to R₄ are each independently C₁-C₂₀alkyl;
R₇ and R₈ are each independently halogen or C₁-C₂₀alkyl;
a, b, c, d, e, and f are each independently an integer of 1 to 3; and
m is an integer of 3 to 5.

3. The metal-ligand complex of claim 1, wherein the metal-ligand complex is represented by the following Chemical Formula 2-1 or the following Chemical Formula 2-2: 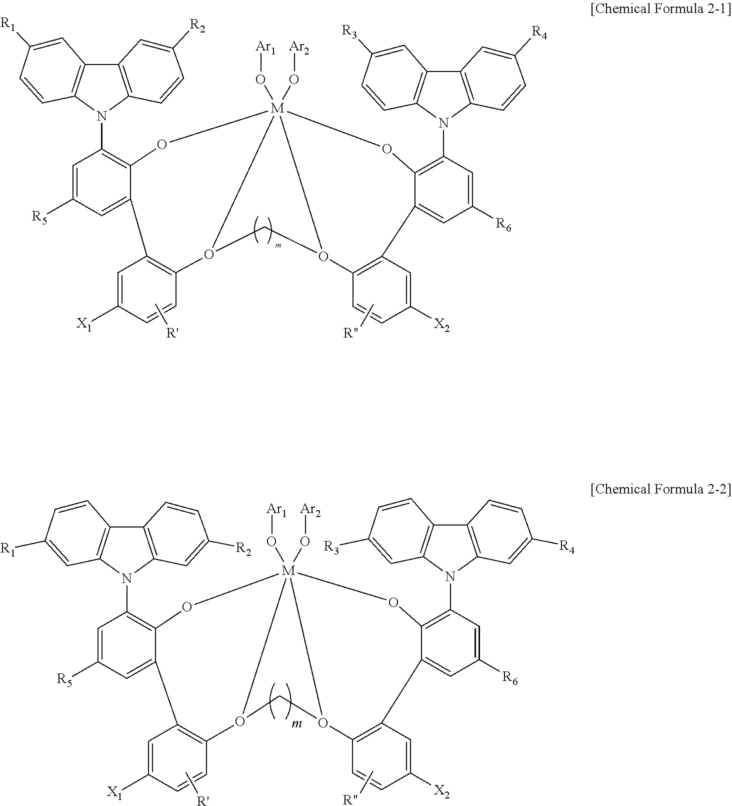
in Chemical Formulas 2-1 and 2-2,
M is titanium, zirconium, or hafnium;
Ar₁ and Ar₂ are each independently C₆-C₂₀aryl or C₁-C₂₀alkylC₆-C₂₀aryl;
R₁ to R₄ are each independently C₁-C₂₀alkyl;
R₅ and R₆ are each independently C₁-C₂₀alkyl;
X₁ and X₂ are each independently halogen;
R′ and R″ are each independently hydrogen or C₁-C₂₀alkyl; and
m is an integer of 3 to 5.

4. The metal-ligand complex of claim 3, wherein
Ar₁ and Ar₂ are each independently C₆-C₁₂aryl or C₁-C₂₀alkylC₆-C₁₂aryl;
R₁ to R₄ are each independently C₁-C₁₀alkyl;
R₅ and R₆ are each independently C₁-C₁₀alkyl; and
R′ and R″ are each independently hydrogen or C₁-C₁₀alkyl.

5. The metal-ligand complex of claim 1, wherein the metal-ligand complex is represented by the following Chemical Formula 3-1 or the following Chemical Formula 3-2: 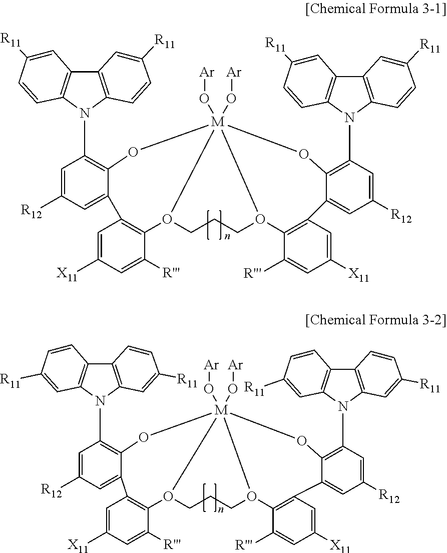
in Chemical Formulas 3-1 and 3-2,
M is zirconium or hafnium;
Ar is C₆-C₁₂aryl or C₁-C₂₀alkylC₆-C₁₂aryl;
R₁₁ is C₁-C₅alkyl;
R₁₂ is C₁-C₁₀alkyl;
X₁₁ is fluoro or chloro;
R′″ is hydrogen or C₁-C₁₀alkyl; and
n is an integer of 1 to 3.

6. The metal-ligand complex of claim 5, wherein the metal-ligand complex is represented by the following Chemical Formula 4-1 or the following Chemical Formula 4-2: 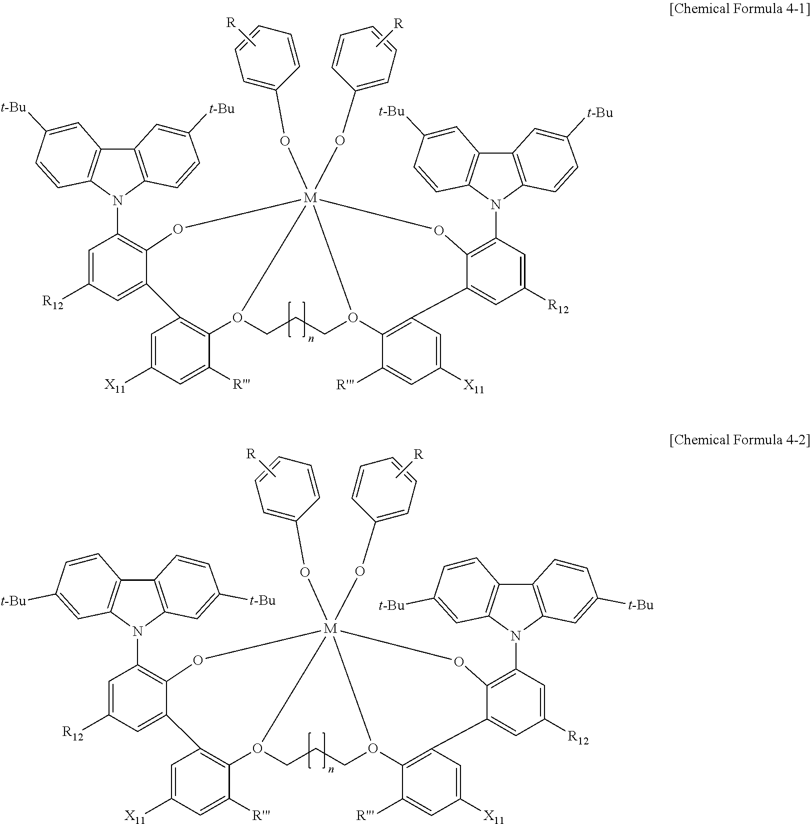
in Chemical Formulas 4-1 and 4-2,
M is zirconium or hafnium;
R is hydrogen or C₈-C₂₀alkyl;
R₁₂ is C₁-C₁₀alkyl;
X₁₁ is fluoro or chloro;
R′″ is hydrogen or C₁-C₁₀alkyl; and
n is an integer of 1 to 3.

7. A catalyst composition for producing an ethylene-based polymer comprising:
the metal-ligand complex of claim 1; and
a cocatalyst.

8. The catalyst composition of claim 7, wherein the cocatalyst is an aluminum compound cocatalyst, a boron compound cocatalyst, or a mixture thereof.

9. The catalyst composition of claim 7, wherein the cocatalyst is used at 0.5 to 10,000 mol with respect to 1 mol of the metal-ligand complex.

10. A method of producing an ethylene-based polymer, the method comprising producing an ethylene-based polymer by polymerizing ethylene or ethylene and an α-olefin in the presence of the catalyst composition for producing an ethylene-based polymer of claim 7.

11. The method of claim 10, wherein the polymerization is performed at 100 to 250° C.
